(19) United States
(12) Patent Application Publication
(10) Pub. No.: US 2022/0211015 A1
(43) Pub. Date: Jul. 7, 2022

(54) NOVELTY PET BED

(71) Applicant: Donald E. Nail, Vancouver, WA (US)

(72) Inventor: Donald E. Nail, Vancouver, WA (US)

(21) Appl. No.: 17/702,159

(22) Filed: Mar. 23, 2022

Related U.S. Application Data
(63) Continuation-in-part of application No. 17/550,907, filed on Dec. 14, 2021.
Application No. 17/550,907 is a continuation of application No. 16/405,283, filed on May 7, 2019, now Pat. No. 11,229,191.
(60) Provisional application No. 62/667,851, filed on May 7, 2018.

(51) Int. Cl. A01K 63/00; F16B 5/00

(52) U.S. Cl. CPC A01K 63/006; F16B 5/0012

(57) ABSTRACT

A novelty pet bed includes a plurality of side panels and a bottom panel interconnected to define a pet bed frame surrounding a void, The novelty pet bed supports and retains plush pet bed. One or more of the side panels defines a window, wherein a pet enters the novelty pet bed through the window.

### CROSS REFERENCE TO RELATED APPLICATIONS

This application claims is a Continuation In Part application, and claims priority to co-pending U.S. Application, Ser. No. 17/550,907,filed Dec. 14, 2021, which claimed priority to U.S. Application, Ser. No. 16/405,283, filed May 7, 2019, which claimed priority to provisional U.S. Application, Ser. No. 62/667,851, filed on May 7, 2018, and all of which are hereby incorporated by reference for all purposes.

### BACKGROUND

The present disclosure relates generally to covers. In particular, novelty covers for tanks and novelty pet beds are described.

Fish tank aquariums and terrariums are a fun and indispensable way to house and display household and exotic pets and animals. For many, having a pet fish or lizard may be a rite of passage as they grow up. For others, the companionship of a low stress and low maintenance house pet like tropical fish or snakes can be a desirable addition to their lives.

Typically, these animals are housed in clear tanks with walls made of glass or plastic. Owners may be creative and fill the tanks with any number of ornaments and decorations to spruce up the habitat of the tank for the animals and to make the tank look more aesthetically pleasing.

However, the glass box of the tank still typically remains unchanged and unappealing. Some may utilize different lids to imitate a roof, but the glass walls of the tank remain bare and exposed. Alternatively, some may paint or apply stickers to the tank to add their own decorations, but these are not easily changed or removed. Thus, there exists a need for tank decorations that cover the tank yet remain easily changeable and removeable to make the tanks more aesthetically appealing to a user.

Additionally, pets such as dogs, cats or the like, typically have a preferred place that they like to rest or sleep. Alternatively, or additionally, the pet owners may have a preferred place that they like their pet(s) to rest or sleep. In some instances, the exterior portion of the pet bed may be made of a rigid or semi-rigid material so as to constrain any soft pet bedding materials within the pet bed.

However, such rigid or semi-rigid exterior portions may be relatively difficult to assemble. Assembly may be particularly difficult if the pet bed is provided in a dissembled state to the pet owner. Accordingly, there is a need in the arts for an easy-to-assemble rigid or semi-rigid exterior portion of a pet bed.

Further, because of movement of the pet into and out of the pet bed, and/or movement of the pet while within the pet bed, may result in eventual separation of the sides of the pet bed. Accordingly, there is a need in the arts for securing the sides of the exterior portion of a pet bed.

### SUMMARY

The present disclosure is directed to novelty pet beds. An example novelty pet bed includes a plurality of side panels and a bottom panel interconnected to define a frame surrounding a void, The novelty pet bed supports and retains plush pet bed. One or more of the side panels defines a window, wherein a pet enters the novelty pet bed through the window.

### BRIEF DESCRIPTION OF THE DRAWINGS

FIG. 1 is a perspective view of a first example of a novelty cover for a tank.

FIG. 2 is an exploded view of the novelty cover shown in FIG. 1.

FIG. 3 is a plan view of a joint cap that is configured to mount to a corner of the novelty cover shown in FIG. 1.

FIG. 4 is a top view of a cover configured to mount to the top of the novelty cover.

FIG. 5 is an exploded view of a second example of a novelty cover for a tank.

FIG. 6 is a plan view of a panel included in the novelty cover for a tank shown in FIG. 5 depicting an accessory aperture.

FIG. 7 is a perspective view of a tank suitable to be covered by the novelty covers shown in FIGS. 1-6.

FIG. 8 is a schematic top view of the tank shown in FIG. 7 disposed inside a frame of the novelty cover shown in FIGS. 1-4 depicting the complementary perimeters of the tank and the frame.

FIG. 9 is a perspective view of an example pet bed.

FIG. 10 is a perspective view of an alternative embodiment of a pet bed.

FIG. 11 is a perspective view of an alternative embodiment of a pet bed.

FIG. 12 illustrates an alternative embodiment of a pet bed.

FIG. 13 illustrates an alternative embodiment of a pet bed.

FIG. 14 illustrates how the example embodiment in FIG. 13 having the scalloped panel may be cut from a single piece of material.

### DETAILED DESCRIPTION

The disclosed novelty covers will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various novelty covers are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Secured to” means directly connected without intervening components.

### Novelty Covers for Tanks

With reference to the figures, novelty covers for tanks will now be described. The novelty covers for tanks discussed herein function to cover a tank in a fun, creative, and decorative fashion. The presently described novelty covers cover the walls and top of a tank while remaining easily removeable and interchangeable because of their modular components.

The novelty covers discussed below address many of the shortcomings existing with conventional tank covers and decorations. For example, the novelty covers easily disconnect at their corners and edges to lay flat. This makes shipping and storage easy and affordable.

Further, the novelty covers fit over a tank, include a standard sized ten-gallon tank, without attaching directly to the tank. This makes the novelty covers easily removable and moveable by simply lifting the novelty cover up and over the tank.

Further, the novelty covers fit together using finger joints and pins and do not require additional tools to assemble or disassemble. The ability to be assembled and disassembled without tools adds to the mobility, convenience, and accessibility of the novelty covers.

Additionally, the novelty covers may come in many different shapes, colors, and designs to provide users with a wide variety of creative options. In many instances, the novelty covers create a cohesive ornamental scene when assembled around a tank. Further addressing the need for users to creatively express themselves, the novelty covers may have alternate attachment pieces to customize the novelty covers to a user's preferences.

### Tank

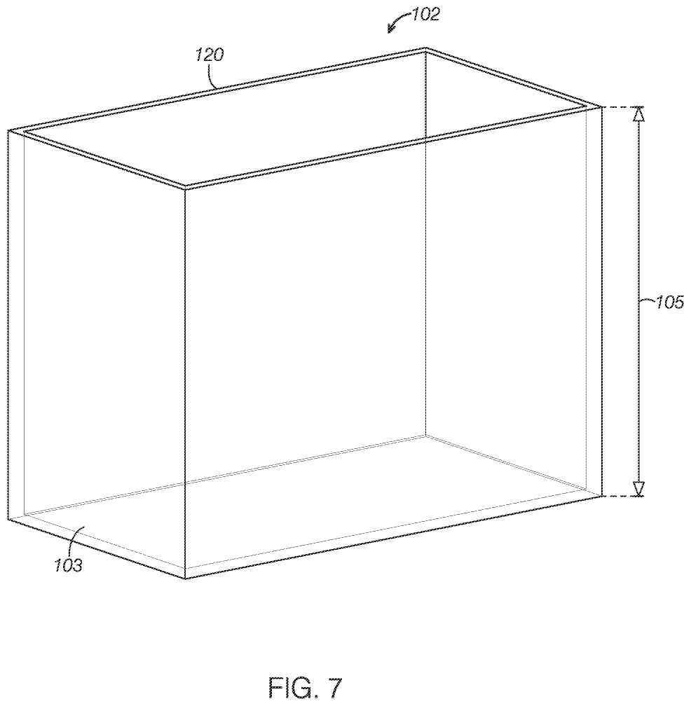

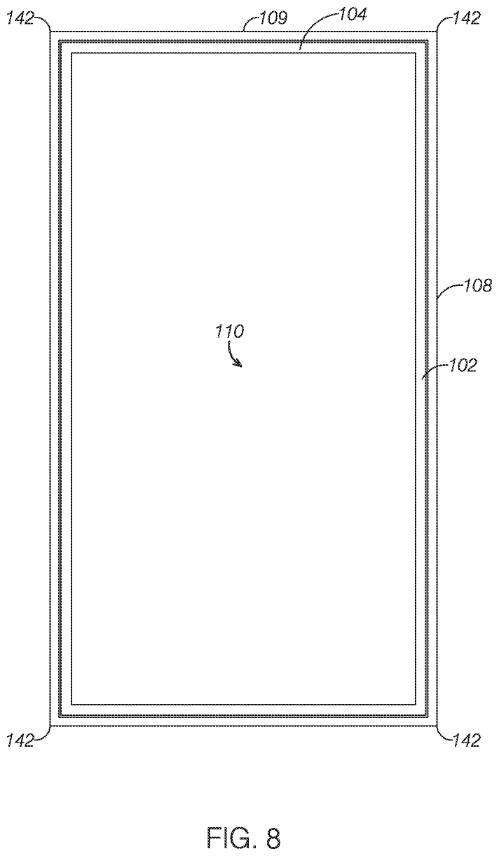

With reference to FIGS. 7 and 8, the features of tank 102 will first be described to aid the discussion of the novelty covers disclosed herein. As shown in FIG. 7, tank 102 includes four tank walls 103 defining a tank perimeter 104 with a top 120 disposed vertically above tank walls 103.

Tank 102 is a standard sized ten-gallon tank with a tank height 105 of 12 inches. The length, width, and height dimensions of tank 102 are 20 inches, 10 inches, and 12 inches, respectively. However, other tanks come in a wide variety of different dimensions and all such dimensions are suitable for use with the novelty covers described herein.

In the present example, tank walls 103 are made of glass. Some tank or aquarium examples may include walls made of plastic and have one or more walls that are not transparent.

The perimeter of tank 102 is rectangular, but suitable tanks may have other shapes and/or more or less than four walls. For example, some tanks may be triangular, square, circular, a pentagon, another regular polygon, or an irregular shape, each with a corresponding number of walls, such as three walls for a triangular shaped tank, etc.

### Novelty Cover Embodiment One

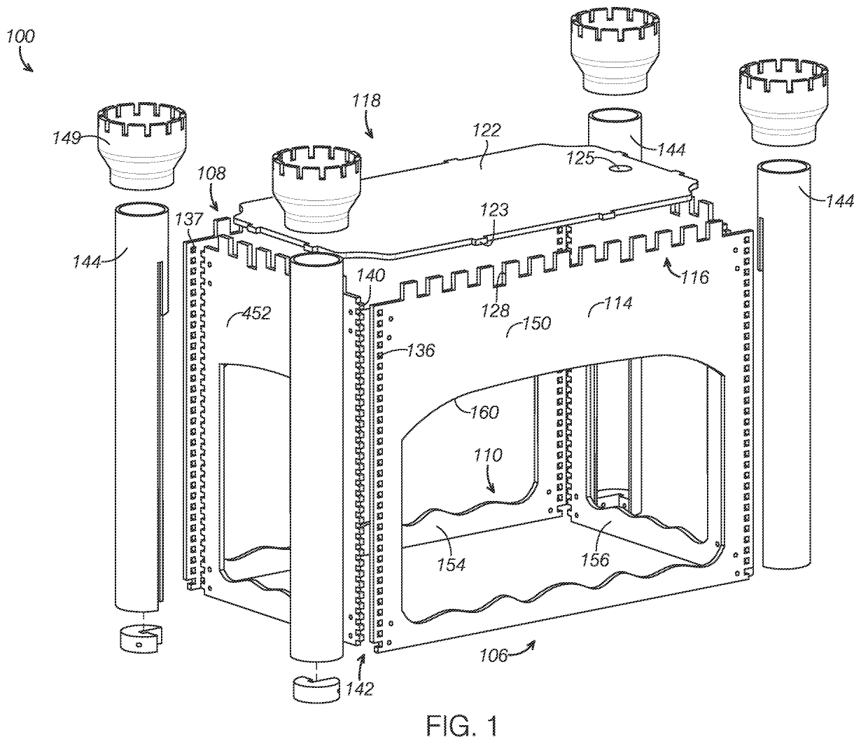

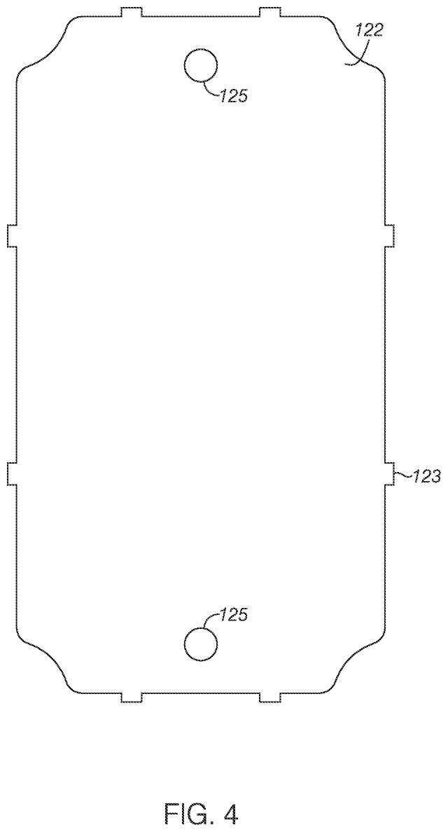

With reference to FIGS. 1-4 and 8, a first example of a novelty cover, novelty cover 100, will now be described. Novelty cover 100 includes a plurality of panels 106, a cover 122, and four joint caps 144.

In some examples, the novelty cover does not include one or more features included in novelty cover 100. For example, some novelty cover examples do not include a cover or a joint cap.

In other examples, the novelty covers includes additional or alternative features. For example, some novelty cover examples include lights, electronic displays, clocks, calendars, writing surfaces, such as chalk boards or dry erase boards, and cord and/or tubing organizers. Additionally or alternatively, the novelty covers may include accessory display items, such as statues, figurines, plush toys, and pictures, in some examples.

### Plurality of Panels

As can be seen in FIGS. 1-3 and 8, plurality of panels 106 interconnect to define a frame 108 surrounding a void 110. As shown in FIG. 8, frame 108 defines a frame perimeter 109, which is complementarily configured with tank perimeter 104. Frame 108 is self-supporting in the sense that it holds together upright without support from tank 102 or another external object.

In the present example, plurality of panels 106 includes four separate panels: first panel 150, second panel 152, third panel 154, and fourth panel 156. In other examples, the plurality of panels include more or less panels, such as three panels, five panels, and six or more panels.

Each of the panels in plurality of panels 106 includes an exterior surface with ornamentation. For example, first panel 150 includes exterior surface 114 with ornamentation 116 in the form of a parapet. The ornamentation on the exterior surfaces of the panels collectively form a cohesive ornamental scene 118 when the panels are interconnected to define frame 108.

The ornamentation and the cohesive ornamental scene can take a wide variety of forms. For example, cohesive ornamental scene 118 in FIGS. 1-3 is a castle. As shown in FIGS. 1-3, each panel includes ornamentation depicting features of a castle, such as stone walls, a drawbridge, windows, and a parapet.

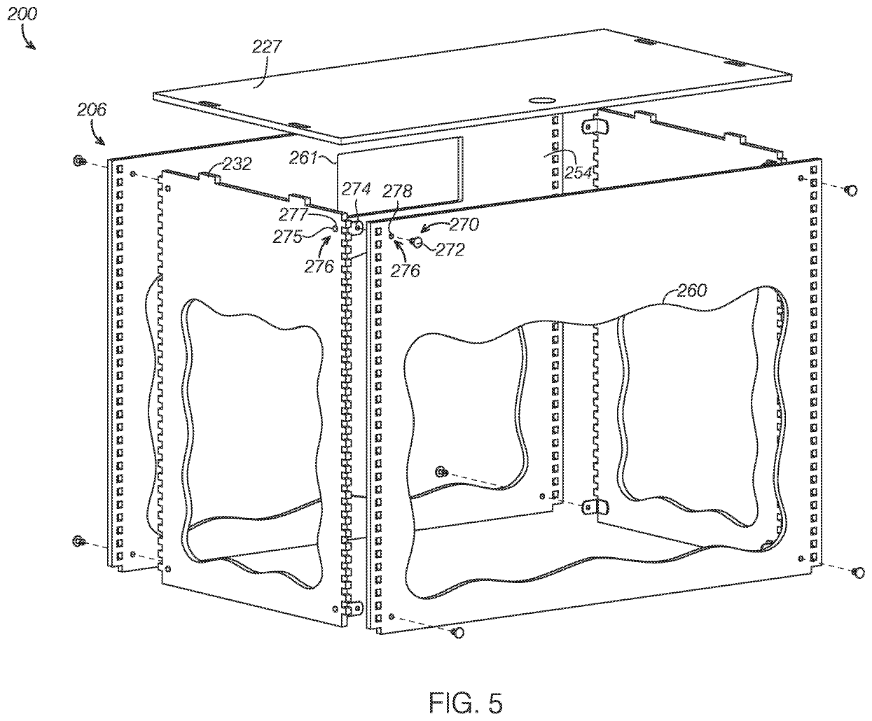

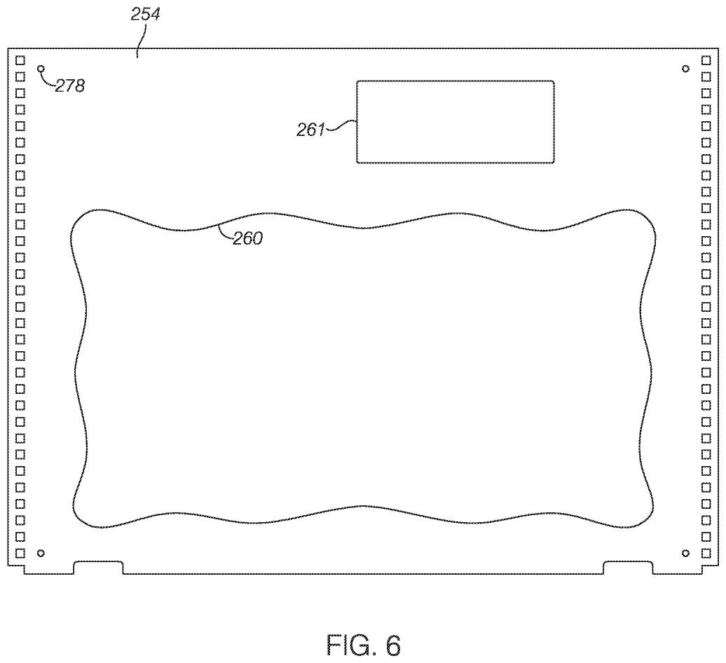

In other examples, such as shown in FIGS. 5 and 6, the cohesive ornamental scene is a treasure chest. In other examples, the cohesive ornamental scene is a pagoda. In some examples, the cohesive ornamental scene is an abstract design, a space ship, a jungle, a house, an Egyptian pyramid, a sports arena, or a circus. There is almost no limit on the range of cohesive ornamental scenes the panels may collectively display when interconnected to define the frame.

As shown in FIGS. 1, 2, and 8, frame 108 is configured to receive tank 102 in void 110. To receive tank 102 in void, a user may place assembled frame 108 over tank 102, may place tank 102 into void 110 of assembled frame 108, or may assemble frame 108 from plurality of panels 106 around tank 102. The reader can see from FIG. 8 that frame perimeter 109 is complementarily configured with tank perimeter 104 so that void 110 is complementarily configured with tank 102. The complementary configuration in the novelty cover 100 example provides a close tolerance leaving relatively little space between frame 108 and tank 102. In other novelty cover examples, the tolerance is more relaxed to provide more space between the frame and the tank. In still other examples, the tolerance is tighter to provide little or no space between the tank and the frame.

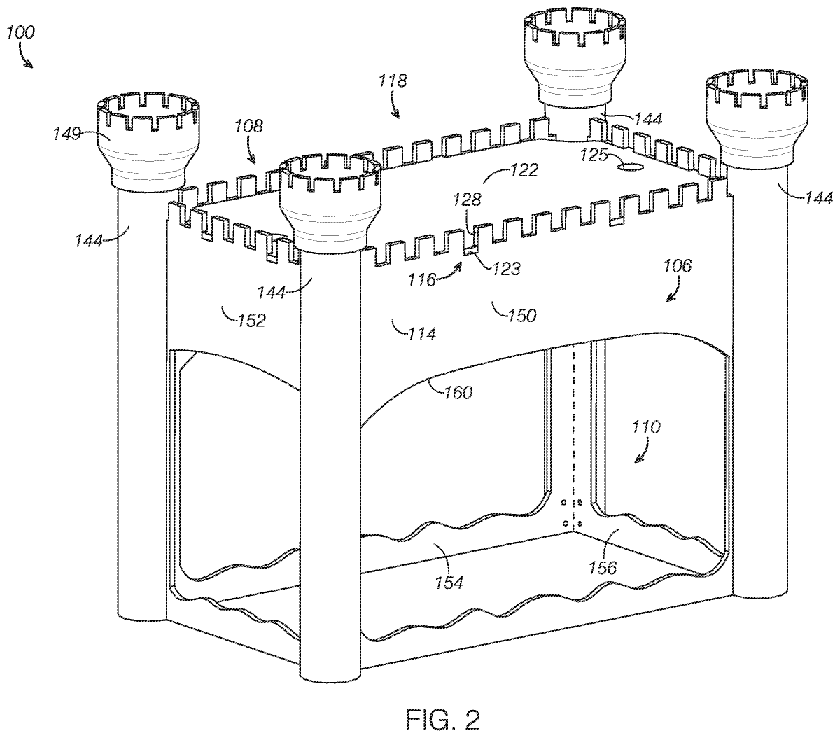

In the example shown in FIGS. 1 and 2, plurality of panels 106 each have a panel height greater than or equal to tank height 105. The panel heights being greater than tank height 105 means that tank 102 is vertically enclosed by frame 108 when received in void 110. In other examples, the height of the panels is equal to or less than the height of the tank.

With reference to FIGS. 1 and 2, the reader can see that first panel 150 in plurality of panels 106 defines a notch 128 proximate where top 120 of tank 102 would be disposed when tank 102 is disposed in void 110. As explained in more detail below, cover 122 is configured to couple with frame 108 in a position overlying top 120 of tank 102 when tank 102 is received in void 110. Thus, notch 128 is in a position proximate to cover 122 when cover 122 is coupled to frame 108 in a position overlying top 120. Notch 128 is complementarily configured with a cover projection 123 to receive cover project 123 in notch 128 to horizontally stabilize cover 122.

As shown in FIGS. 1 and 2, first panel 150 defines a window 160 permitting tank 102 to be seen through first panel 150 when tank 102 is received in void 110 of frame 108. In the example shown in FIGS. 1 and 2, second panel 152, third panel 154, and fourth panel 156 also define windows through which tank 102 can be observed from outside frame 108. In some examples, fewer than all panels define windows, such as a single panel, two panels, or three panels defining a window.

In the example shown in FIGS. 1 and 2, window 160 consists of an absence or hole through first panel 150. In other examples, the windows may be a clear material integrated into the panels. In certain examples, the windows are an absence of panel material and include glass or another clear material covering them.

The reader can see in FIGS. 1 and 2 that window 160 represents a major portion of first panel 150. In this context, major portion means the area of first panel 150 defining window 160 is greater than the area of first panel 150 not defining window 160. Expressed another way, window 160 represents more than half the area defined by exterior surface 114. The larger the window area, the less that tank 102 is obscured by the panel, which enables a user to view more of tank 102 and its contents.

With reference to FIGS. 1 and 2, the reader can see that first panel 150 defines a series of holes 136 proximate outer edges of first panel 150. Third panel 154 defines a similar series of holes 137 to series of holes 136. The reader can also see that second panel 152 includes a series of projections 140 proximate outer edges of second panel 152. Series of projections 140 are configured to matingly engage series of holes 136 in first panel 150 as well as series of holes 137 defined in third panel 154.

Series of projections 140 matingly engaging series of holes 136 interconnects second panel 152 with first panel 150. Likewise, series of projections 140 matingly engaging series of holes 137 interconnects second panel 152 with third panel 154. By configuring two opposite panels with a series of holes and two adjacent panels with a series of projections, the series of panels matingly engage to interconnect as a rectangle. Thus, as shown in FIG. 8, in the present example, tank perimeter 104 is rectangular and frame perimeter 109 is correspondingly rectangular. Wherein two panels interconnect defines a vertically extending joint 142.

In some examples, the interconnected panels are secured together proximate vertically extending joint 142 with fasteners while in other examples fasteners are not used. In examples where fasteners are used, such as the example shown in FIGS. 5 and 6, the fasters may be operable by hand without requiring tools.

For example, some examples include hand screw fasteners to secure the panels together, such as two hand screw fasteners per vertical edge of the frame. The hand screw fasteners include a screw configured to be operated by hand and a bracket configured to receive the hand screw. When hand screw fasteners are used, the panels may include complementary hole-pairs in adjacent panels to accommodate the hand screw fastener: one type of hole configured to mount the bracket via a bracket projection and another type of hole through which the hand screw may pass to reach the bracket mounted to the adjacent panel. In use, a user secures the bracket to one of the panels (or the bracket comes preinstalled on the panel) and then the user inserts the hand screw through the other hole in the hole-pair formed in the adjacent panel and into the bracket to secure the adjacent panels together.

### Cover

With reference to FIGS. 1, 2 and 4, the reader can see that cover 122 is configured to couple with frame 108 in a position overlying top 120 of tank 102 when tank 102 is received in void 110. Cover 122 is unadorned, but some examples will include adornments or accessory display items, such as statues, figurines, plush toys, and pictures. For example, when the cohesive ornamental scene is a pagoda, the cover may include adornments in the form of dragon statue replicas.

As shown in FIGS. 1, 2 and 4, cover 122 includes a series of cover projections 123 configured to rest in notches 128 formed in first panel 150, second panel 152, third panel 154, and fourth panel 156. Projections 123 residing in notches 128 serves to horizontally stabilize cover 122 on frame 108. In other examples, such as the example shown in FIG. 5, the cover defines one or more cover apertures complementarily configured with vertical projections extending from the panels. The cover apertures are aligned with the vertical projections and receive the vertical projections to orient and laterally stabilize the cover.

In the present example, cover 122 includes finger holes 125 to facilitate lifting cover 122. In other examples, finger holes are not defined in the cover. Additionally or alternatively to finger holes, the cover may include handles to facilitate lifting and maneuvering the cover.

### Joint Cap

With reference to FIGS. 1-3, the reader can see that novelty cover 100 includes four joint caps 144 mounted to four vertically extending joints 142. In other examples of the novelty cover, joint caps are not provided at all or fewer joint caps than the number of vertically extending joints present are provided. Joint caps 144 press two adjacent panels together to interconnect them more securely when mounted to vertically extending joint 142 defined between the adjacent panels.

The reader can see from FIGS. 1-3 that joint caps 144 have an ornamental exterior appearance, including a cap 149 depicting a turret, which complements the ornamentation on the exterior surfaces of the panels. In the present example, joint caps 144 appear as castle turrets to complement the castle cohesive ornamental scene created by frame 108. In examples where the cohesive ornamental scene is a spaceship, the joint caps may appear as rocket engines. The reader will appreciate that the joint caps may adopt any external ornamentation suitable to complement the cohesive ornamental scene presented by the frame.

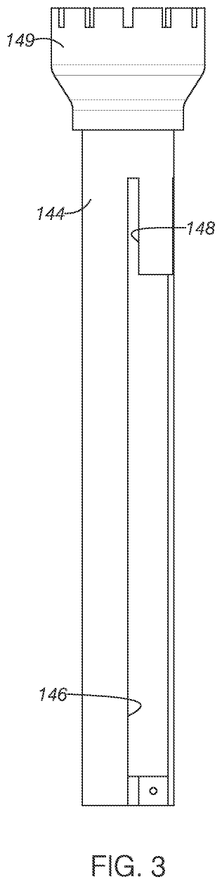

With reference to FIGS. 2 and 3, one can see that joint caps 144 each define a vertically extending recess 146 complementarily configured with vertically extending joints 142. As shown in FIG. 3, joint cap 144 defines a slit 148 vertically adjacent to vertically extending recess 146. Slit 148 is complementarily configured with a minor dimension of the panels in plurality of panels 106. The minor dimension of the panels corresponds to the thickness of the panels. Expressed another way, the minor dimension is the spacing distance between the exterior and interior faces of the panels.

The complementary configurations of recess 146 and slit 148 relative to vertically extending joint 142 and the minor dimension of the panels, respectively, allows joint caps 144 to mount securely to frame 108 at the four vertically extending joints 142. In particular, joint cap 144 receives vertically extending joint 142 in vertically extending recess 146. Further, slit 148 receives a portion of a panel; more specifically, slit 148 receives one of the two panels interconnected to form vertically extending joint 142.

### Novelty Cover Embodiment Two

Turning attention to FIGS. 5 and 6, a second example of a novelty cover, novelty cover 200, will now be described. Novelty cover 200 includes many similar or identical features to novelty cover 100. Thus, for the sake of brevity, each feature of novelty cover 200 will not be redundantly explained. Rather, key distinctions between novelty cover 200 and novelty cover 100 will be described in detail and the reader should reference the discussion above for features substantially similar between the two novelty covers.

As can be seen in FIG. 5, novelty cover 200 includes a plurality of panels 206 and a cover 222. In contrast to the castle cohesive ornamental scene presented by novelty cover 100, novelty cover 200 presents a sea chest cohesive ornamental scene. Plurality of panels 206 define windows 260 through which a tank and its contents may be observed.

FIGS. 5 and 6 show that novelty cover 200 has a different configuration for securing the cover to the plurality of panels than present in the novelty cover 100 example. In the novelty cover 200 example, plurality of panels 206 define vertical projections 232 proximate cover 222 and cover 222 defines cover apertures 227 complementarily configured with vertical projection 232. Cover apertures 227 align with vertical projections 232 and receive vertical projections 232 to orient and laterally stabilize cover 222.

As shown in FIGS. 5 and 6, a panel 254 in plurality of panels 206 defines an accessory aperture 261. Accessory aperture 261 provides access to a tank disposed in novelty cover 200 for accessories located outside novelty cover. Additionally or alternatively, accessory aperture 261 provides a place to mount accessories to panel 254. Common accessories for which it is beneficial to provide access to the tank are pumps, filtration units, lamps, food dispensers, and water dispensers. The accessory aperture may be sized and shaped to complement any desired accessory.

As shown in FIG. 5, novelty cover 200 includes hand screw fasteners 270 to help secure plurality of panels 206 together. In particular, novelty cover 200 includes two hand screw fasteners 270 per vertical edge of the frame. Hand screw fasteners include a screw 272 configured to be operated by hand and a bracket 274 configured to receive hand screw 272.

In FIGS. 5 and 6, the reader can see that plurality of panels 206 defines complementary hole-pairs 276 in adjacent panels to accommodate hand screw fastener 270. A first hole 277 in hole-pair 276 is configured to mount bracket 274 via a bracket projection 275. A second hole 278 in hole-pair 276 is configured for screw 272 to extend through it to reach bracket 274.

In use, a user secures bracket 274 to one of the panels (or bracket 274 comes preinstalled on the panel) via first hole 277. To secure the panels together, the user inserts hand screw 272 through second hole 278 formed in the adjacent panel and then into bracket 274 to secure the adjacent panels together.

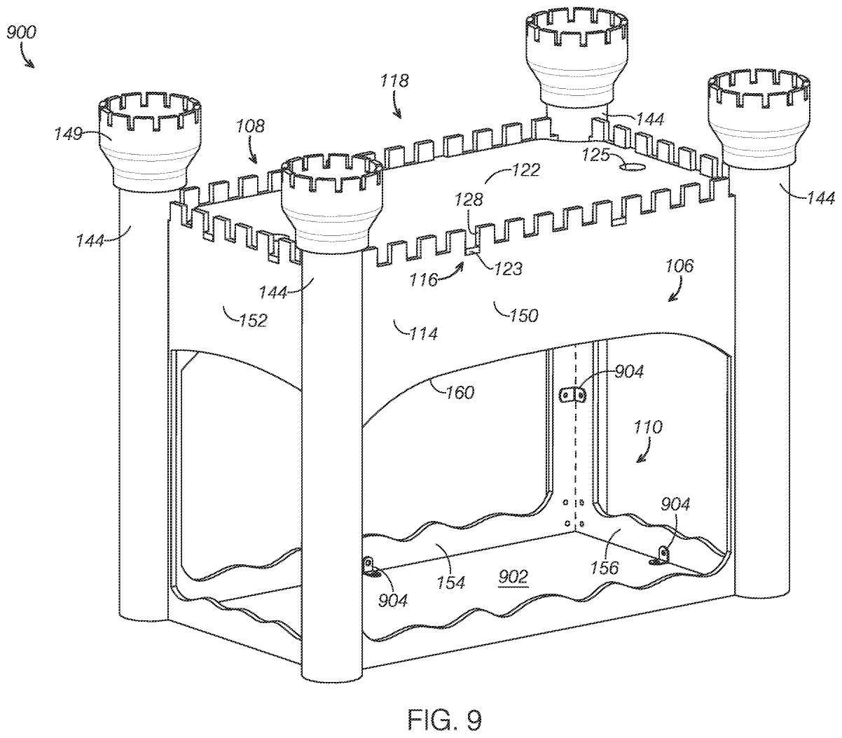

FIG. 9 is a perspective view of an example pet bed 900. The appearance of the example pet bed 900 resembles the above-described novelty cover 100. The non-limiting embodiment of the pet bed 900 includes a plurality of panels 106, an optional cover 122, and four joint caps 144 similar to those elements of the novelty cover 100. Also included as a component of the pet bed 900 is a bottom panel 902. Preferably, a soft pet bedding material (interchangeably referred to as a plush pet bed) rests on the bottom panel 902. The plurality of side panels 106 cooperatively retain the soft pet bedding material within the pet bed 900. In alternative embodiments, the pet bed 900 may not include one or more features included in novelty cover 100. For example, some pet bed 900 examples do not include a cover 122 and/or the joint caps 144. Further, a pet bed 100 may have any ornamentation and/or appearance.

The plurality of panels 106 interconnect to define a frame 108 surrounding a void 110 sized to receive the soft pet bedding material and a pet. The plurality of panels 106 includes four separate panels: first panel 150, second panel 152, third panel 154, and fourth panel 156 (generically referred to herein as the plurality of panels 106). The size and dimensions of the void 110 can be varied as needed to accommodate any size of soft pet bedding material and/or any particular pet of interest.

One or more of the panels in plurality of panels 106 include an exterior surface with optional ornamentation. For example, the first panel 150 includes exterior surface 114 with ornamentation 116 in the form of a parapet. The ornamentation on the exterior surfaces of the panels collectively form a cohesive ornamental scene 118 when the panels are interconnected to define a pet bed frame 108. The interior surfaces of the panels 106 may optionally have ornamentation. Any ornamentation of interest may be used in the various embodiments of the pet bed 900.

In the example embodiment of a pet bed 900, the first panel 150 defines a window 160 permitting a pet to enter into the void 110 of frame 108. In the example shown in FIG. 9, the second panel 152, third panel 154, and fourth panel 156 may also optionally define windows through which the pet may enter or exit the void 110. Also, the windows permit the pet to observe the surrounding area while in the pet bed 900. In some example embodiments, only a single panel, two panels, or three panels may define a window.

Preferably, the bottom panel 902 is secured to one or more of the plurality of panels 106. Securing the bottom panel 902 to the side panels 106 further secures and reinforces the structure of the pet bed 900. In some embodiments one or more securing brackets 904 may be used to secure the bottom panel 902 to one or more of the panels 106. A securing bracket 904, made of a suitable rigid plastic, metal or other suitable material, may be secured to the bottom panel 902 and the corresponding panel 106 using a screw, a bolt and nut, rivets, nails and/or adhesive. Screws and nails may not be preferable because the sharpened ends may be harmful to the pet and/or pet owner. Optionally, one or more securing brackets 904 may be used to secure the first panel 150, the second panel 152, the third panel 154, and the fourth panel 156 with the adjacent panels 106.

Once the first panel 150, the second panel 152, the third panel 154, the fourth panel 156 and the bottom panel 902 are secured together using joint caps 144, hook and slot attachments, and/or securing brackets 904, the pet bed 900 provides a rigid frame 108. The rigid frame 108 permits the pet to enter the pet bed 900, exit the pet bed 900, sleep in the pet bed 900, and even play within the pet bed 900 without damaging the pet bed 900.

An unexpected benefit of embodiments of the pet bed 900 is that the components (panels 106, the bottom panel 902 and the optional cover 122) may be supplied to the pet owner in a dissembled configuration. The pet owner may easily assemble the pet bed 900, and then secure the pet bed 900 into the rigid frame 108 using the various securing means disclosed herein. Shipping costs and retail shelf space costs may be reduced by providing the pet bed 900 in an unassembled form residing is a secure container. Further, the unassembled pet bed 900 is easily transportable.

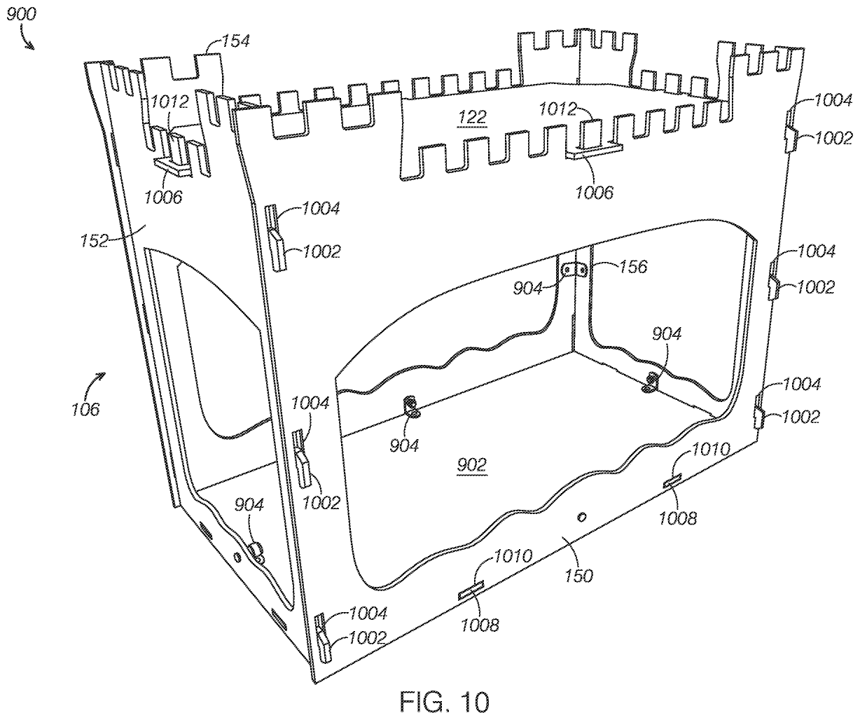

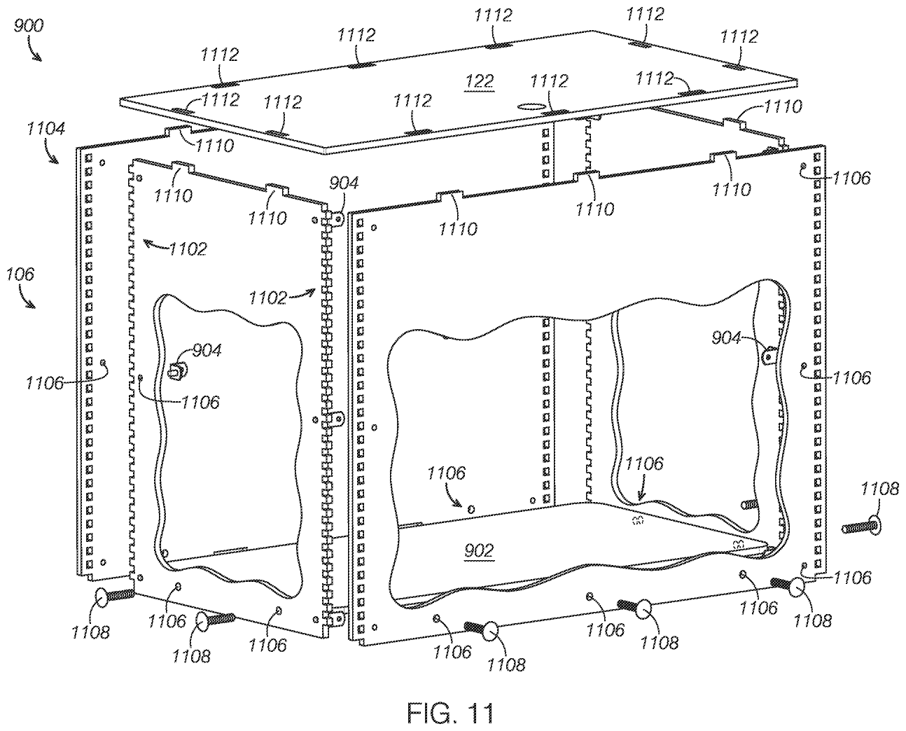

FIGS. 10-11 are perspective views of alternative embodiments of a pet bed 900. These example embodiments employ various means of securing the first panel 150, the second panel 152, the third panel 154, the fourth panel 156, the bottom panel 902 and the optional cover 122 together to form the rigid and secure frame of the pet bed 900. One or more of the securing means illustrated in FIGS. 9-11 may be used in the various embodiments.

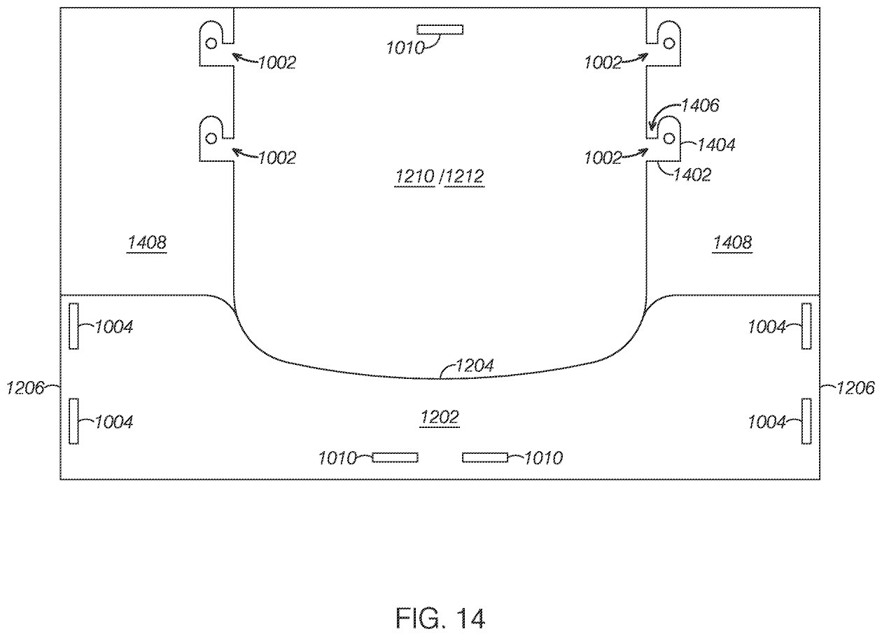

FIG. 10 illustrates the use of a plurality of hooks 1002 and slots 1004 as the securing means. In this example embodiment, edges of the panels 152 and 156 have outward protruding hooks 1002. Each hook 1002 is defined by a proximal outwardly protruding member 1402 and a distal downwardly protruding member 1404 (see FIG. 14). The outwardly protruding member 1402 and a distal downwardly protruding member 1404 cooperatively define an engaging interior area 1406 of the hook 1002. The engaging interior area 1406 is defined by a width, wherein the width of the engaging interior area corresponds, or substantially corresponds, to a thickness of the second one of the four side panels such that a friction secure fit occurs between a portion of the panel 106 proximal to and below the slot 1004 and the inside surface of the downwardly protruding member 1404. A plurality of corresponding slots 1004 are disposed proximate the edges of the panels 150 and 154 to receive the corresponding hook 1002.

During assembly, the user perpendicularly orients two adjacent panels 106 in proximity to each other, and then slides the hooks 1002 of one of the panels 106 through the corresponding slots 1004 of the adjacent panel 106. For example, the hooks 1002 of the panels 152, 156 are slid through the corresponding slots 1004 of the panels 150, 154. Then, the user pushes the panels 152, 156 downward so that the engaging interior area 1406 of the hooks 1002 frictionally engage the wall of the adjacent panel 150, 154 proximate to and below the slots 1004. The hooks 1002, when pushed through the slots 1004 and then pushed downward, then holds the adjacent panels 106 together. In some embodiments, the thickness of the material of panels 150, 154 corresponds to the width of the engaging interior area of the hook 1002 such that a relatively tight frictional fit between the panel walls and the hook 1002 occurs. One or more securing brackets 904 may then be used to further secure the first panel 150, the second panel 152, the third panel 154, the fourth panel 156, and the bottom panel 902 together. The hooks 1002 and slots 1004 may be disposed on any of the panels 106 such that the hooks 1002 and slots 1004 cooperatively secure the adjacent panels together. For example, but not limited to, the hooks 1002 may be disposed on the panels 150, 154 and the slots 1004 disposed on the panels 152, 156.

FIG. 10 further illustrates an alternative securing means to secure the optional cover 122 to the top edge of the panels 106. In this illustrative embodiment, the top edge of the first panel 150, the second panel 152, the third panel 154, and the fourth panel 156 have one or more upwardly protruding panel tabs 1012 (for example, a plurality of panel tabs 1012 create an ornamental parapet with notches for a castle-themed pet bed 900). The cover 122 includes one or more protruding cover tabs 1006 that extends beyond an outside surface of the corresponding side panel 106. A slot or other corresponding aperture is disposed in the cover tab 1006 that is sized to receive the corresponding protruding panel tab 1012 . When the user pushes the cover 122 downward, the slot of the cover tabs 1006 concurrently engage the corresponding protruding panel tabs 1012 on the panels 150, 152, 154, 156. Accordingly, the cover 122 become secured to the panels 106. Further, the cover 122 when secured to the panels 106 further improves the rigidity of the pet bed 900. In some embodiments, the thickness of the material of panels 106 corresponds to the width of the slot of the cover tab 1006 such that a relatively tight friction fit between the protruding panel tabs 1012 and the cover tabs 1006 occur. Optimally, one or more securing brackets 904 may be used to further secure the cover 122 to the panels 106.

FIG. 10 further illustrates an alternative securing means to secure the bottom panel 902 to the bottom edge of the panels 106. The bottom panel 902 includes at least one outwardly protruding tab 1008. The panels include slots 1010 in corresponding location of the tabs 1008, and has a size that corresponds to the dimensions of the protruding tab 1008. During assembly, as two adjacent panels 160 are secured together, the user concurrently inserts the protruding tab 1008 on the bottom panel 902 through the corresponding slot 1010 disposed proximate to the bottom edge of those panels 106. Once the four panels are secured to together in an adjacent manner, the bottom panel 902 is secured by the protruding tabs 1008 that are engaged with the corresponding slots 1010 in the panels 106. Any suitable number of protruding tabs 1008 and corresponding slots 1010 of any suitable size (dimension) may be used in the various embodiments.

Preferably, after the example pet bed 900 illustrated in FIG. 10 has been assembled using the hooks 1002 and slots 1004 of the panels 106, and/or the protruding tabs 1008 of the bottom panel 902, one or more securing brackets 904 are used to permanently secure the panels 106 and/or the bottom panel 902 to each other. Any suitable number of securing brackets 904 may be used in the various embodiments. For example, a greater number of securing brackets 904 may be used when the pet bed 900 is sized to accommodate a large dog, such as a Great Dane or a Saint Bernard. A fewer number of securing brackets 904 may be used when a relatively small pet bed 900 is sized to accommodate a small pet, such as, but not limited to, a cat. Further, the thickness of the panels 106, the bottom panel 902, and/or the cover 122 may be varies to provide a secured rigid pet bed 900 that is suitable for the pet that is using the pet bed 900.

FIG. 11 is a perspective view of an alternative embodiment of a pet bed 900 that employs a panel 106 having a series of notches 1102 that are configured to be inserted into a plurality of corresponding holes 1104 disposed on an adjacent panel 106. During assembly of the pet bed 900, two adjacent panels are oriented perpendicular to each other and then the panels 106 are pushed together so that the notches 1102 engage the corresponding holes 1104 of the adjacent panel 106. The plurality of notches 1102 engage with the corresponding holes 1104 of an adjacent panel 106 and provide a frictional fit with each other such that the adjacent panels 106 become secured together.

Then, a plurality of securing brackets 904 may be sued to permanently secure the adjacent panels to each other and to secure the bottom panel 902 to the panels 106. Preferably, the unassembled panels 106 and/or the bottom panel 902 include predrilled holes 1106 that are at locations that correspond to the designed locations that the securing brackets 904 are to be placed. In some embodiments, a screw 1108 may be configured to be secured to a securing bracket 904. Here, the diameter of the threaded portion of the screw 1108 corresponds to the diameter of the predrilled hole 1106. The threads of the screw 1108 correspond to the threads of the securing bracket 904 such that when the screw 1108 is turned into the corresponding threaded hole of the securing bracket 904, the threads mateably engage to frictionally secure the securing bracket 904 to the two adjacent panels 106 and/or the bottom panel 902. Preferably, the distal end of the screw 1108 is not sharpened, and does not substantially protrude from the securing bracket 904.

FIG. 11 further illustrates an alternative securing means to secure the cover 122 to the upper edge of the panels 106. The top edge of the panels 106 include at least one outwardly protruding tab 1110. The cover 122 includes slots 1112 in corresponding locations and having a size that corresponds to the dimensions of the protruding tab 1110. During assembly, after the four adjacent panels 160 are secured together, the user then inserts the protruding tabs 1110 on the top edges of the panels 106 through the corresponding slots 1112 disposed proximate to the edges of the bottom panel 902. Once the bottom panel 902 and the four panels 106 are secured to together, securing brackets 904 may be optionally used to permanently secure the cover 122 to the panels 106. Any suitable number of protruding tabs 1008 and corresponding slots 1010 of any suitable size (dimension) may be used in the various embodiments.

The embodiments illustrated in FIGS. 9-11 have relatively high panels 106 with a window 160 disposed in at least one of the panels 106 to permit entry into and exit from the pet bed 900 by the pet. The optional cover 122 may be used to further secure the pet bed 900 into a rigid structure, and to provide comfort to the pet by providing a fully enclosed interior within the pet bed 900 that retains the soft pet bedding material.

The exterior and/or interior of the pet bed 900 may be decorated in any suitable manner. For example, the pet bed 900 illustrated in FIGS. 9-10 correspond to a castle. In FIG. 9, the joint caps 144 that resemble turrets of a castle were used to further secure the pet bed 900.

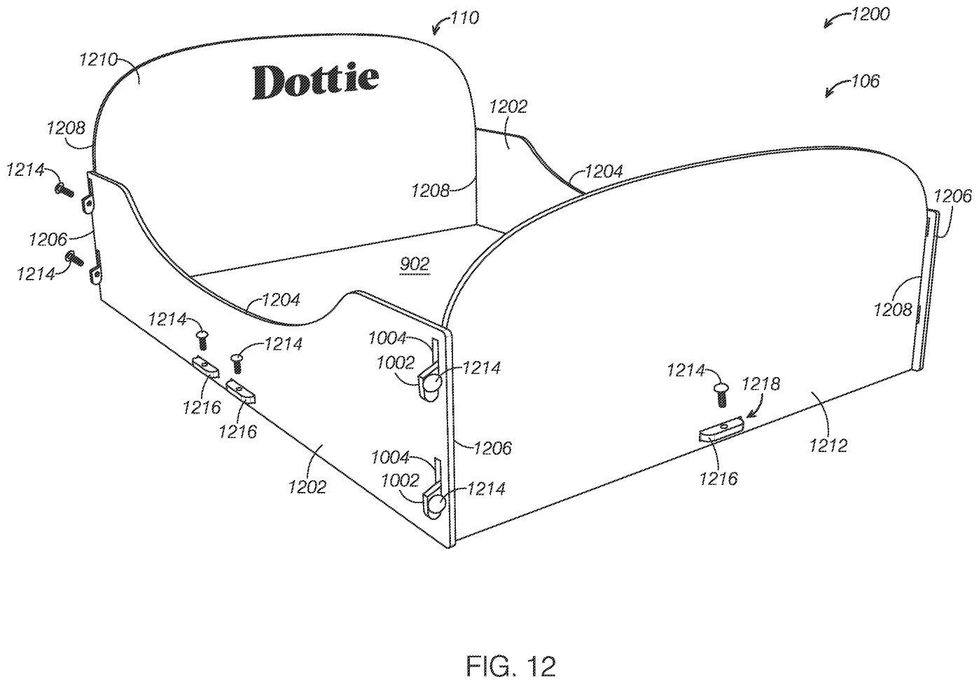

FIG. 12 illustrates an alternative embodiment of a pet bed 1200. The pet bed 1200 has relatively shorter height panels 106 such that the pet bed 900 does not provide a fully enclosed interior. Rather, this configuration of the pet bed 1200 provides the void 110 having an open air configuration. To enter or exit the pet bed 900, the pet jumps over the scalloped panel 1202 that has a scalloped top edge portion 1204. The scalloped top edge portion 1204 is lower than the side edges 1206 of the scalloped panel 1202 to facilitate easy and convenient entry or exit of the pet from the pet bed 1200.

The higher side edges 1206 of the scalloped panel 1202 are configured to be secured to the corresponding side edges 1208 of a headboard panel 1210 and the corresponding side edges 1208 of a backboard panel 1212. The lower edges of the scalloped panels 1202, the front panel 1201, and the backboard panel 1212 are configured to be secured to the bottom panel 902. In the illustrated embodiment of FIG. 12, two scalloped panels 1202 are used for the pet bed 120, preferably as the side panels of the pet bed 1200. In other embodiments, a single panel 106 may be scalloped. Alternatively, more than two panels 106 may be scalloped.

As illustrated in FIG. 12, side edges 1208 of the headboard panel 1210 and the backboard panel 1212 include one or more outwardly protruding hooks 1002. A plurality of corresponding slots 1002 are disposed proximate the edges of the scalloped panels 1202 to receive the corresponding hook 1002. During assembly, the user perpendicularly orients two adjacent panels 106 in proximity to each other, and then slides the hooks 1002 of one of the panel 106 through the corresponding slot 1004. For example, the hooks 1002 of the headboard panel 1210 and the backboard panel 1212 are slid through the corresponding slots 1004 of the scalloped panels 1202. Then, the user pushes headboard panel 1210 and the backboard panel 1212 downward so that the engaging interior area 1406 of the hooks 1002 engage the wall of the scalloped panels 1202 proximate to and below the slots 1004. The hooks 1002, when pushed through the slots 1004 and then pushed downward, then holds the adjacent panels 106 of the pet bed 1200 together. In some embodiments, the thickness of the material of scalloped panels 1202 corresponds to the width of the engaging interior area of the hook 1002 such that a relatively tight friction fit between the panel walls and the hook 1002 occurs.

The hooks 1002 and slots 1004 may be disposed on any of the panels 106 such that the hooks 1002 and slots 1004 cooperatively secure the adjacent panels together. For example, but not limited to, the hooks 1002 may be disposed on the headboard panel 1210 and the backboard panel 1212, and the slots 1004 may be disposed on the scalloped panels 1202.

The distal downward protruding portion 1404 of the hook 1002 has a hole configured to receive a push pin 1214. After the pet bed 1200 has been assembled, the user pushes one of the push pins 1214 through the hole on the protruding portion 1404 of the hook 1002. The push pin 1214 is preferably made of a flexible or deformable material such that, when pushed through the hole on the hook 1002, a frictional fit occurs between the push pin 1214 and the hook 1002. Preferably, the inserted push pin 1214 cannot be removed, or is not easily removed, from the hole of the hook 102. The structure of the push pin 1214 prevents withdrawal of the hook 1002 from the slot 1004, thereby permanently securing the panels 106 of the pet bed 1200 together.

FIG. 12 further illustrates an alternative securing means for securing the bottom panel 902 to the side panels 106. The edges of the bottom panel 902 include one or more protruding tabs 1216 that are configured to pass through corresponding slots 1218 disposed proximate to the lower edges of the panels 106. A portion of the protruding tab 1216 extends outwardly beyond the exterior surface of the panel 106. A hole disposed in this outwardly protruding portion of the protruding tab 1216. The hole is configured to receive and secure a push pin 1214. Once the push pin 1214 is inserted into the hole of the protruding tab 1216, the protruding tab 1216 cannot be disengaged from the slot 1218.

Any suitable number of protruding tabs 1216 may be used to secure any side of the bottom panel 902 to one of the side panels 106. Further, the example protruding tabs 1216 may be used to secure adjacent side panels 106 together.

In some embodiments, joint caps 144 may be added to further secure the four corners of the pet bed 1200. The joint caps 144 would have slots sized so as to be placed onto the corners of the pet bed 1200 after the adjacent sides of the panels 106 have been secured together.

The pet bed 1200 may be decorated with any suitable ornamentation or color of interest. In the example embodiment illustrated in FIG. 12, the pet's name “Dottie” is printed on the interior surface of the headboard panel 1210. The pet's name may be printed on any surface of interest of the panels 106.

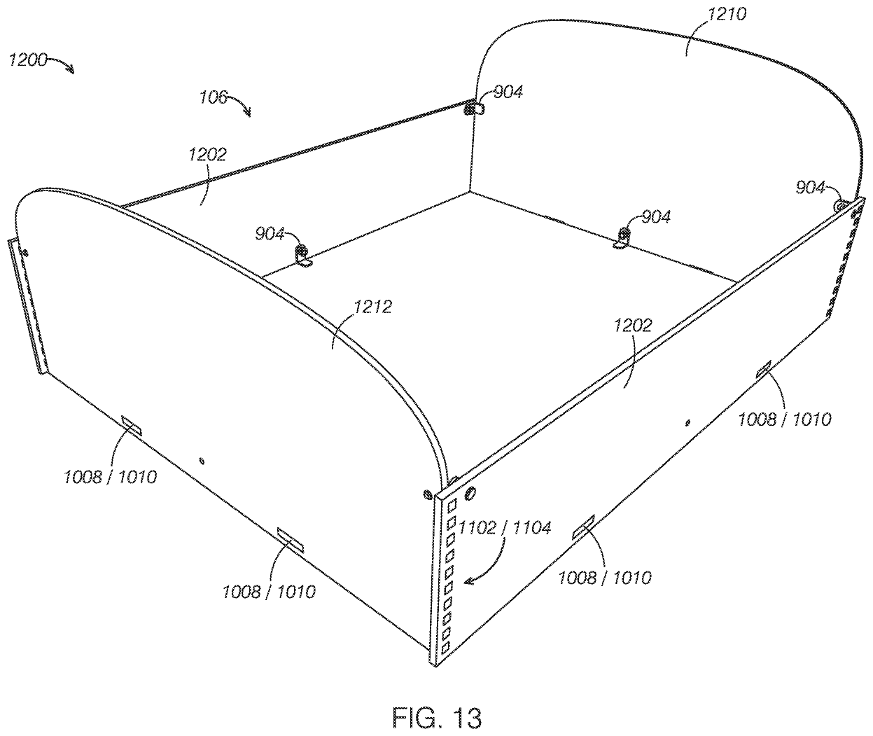

FIG. 13 illustrates an alternative embodiment of a pet bed 1200. Components and securing means previously described herein are not again described for brevity. In this example embodiment, the side panels 1202 are not scalloped. In other embodiment, the top edge of a side panel 1202 may have any shape of interest.

FIG. 14 illustrates how the example embodiment in FIG. 13 having the scalloped panel 1202 may be cut from a single piece of material, such as plastic, wood or metal. Components and securing means previously described herein are not again described for brevity.

The hooks 1002 and slots 1004 may be created during the fabrication process. As noted herein, each hook 1002 is defined by a proximal outwardly protruding member 1402 and a distal downwardly protruding member 1404. The outwardly protruding member 1402 and a distal downwardly protruding member 1404 cooperatively define an engaging interior area 1406 of the hook 1002 that engages with a slot 1004.

Here, an unexpected advantage of fabricating a sleigh type pet bed 1200 for a sheet of material is that material wastage may be minimized. Here, the portions 1408 are waste material. Alternatively, the portions 1408 may be utilized for other components, such as, but not limited to, a joint cap 144.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A novelty pet bed comprising:
four side panels interconnectable to define a pet bed frame,
wherein the four side panels of the pet bed frame define a void configured to receive a plush pet bed, and
wherein two adjacent side panels interconnect to define a vertically extending joint;
a bottom panel interconnectable to a lower edge of each of the four side panels, wherein the bottom panel when connected to the four side panels define the pet bed frame that supports the plush pet bed and retains the plush pet bed within the void; and
a joint cap mounted to the vertically extending joint to secure the two adjacent side panels to each other,
wherein a height of the joint cap is greater than a height of the vertically extending joint,
wherein a lower portion of the joint cap defines a vertically extending recess complementarily configured with a lower portion of the vertically extending joint,
wherein the joint cap defines a vertically oriented slit adjacent to and extending upwardly from the vertically extending recess to at least the height the vertically extending joint,
wherein a length of the slit and the length of the vertically extending recess together is at least equal to a height of the two adjacent side panels,
wherein the joint cap receives the vertically extending joint in the vertically extending recess,
wherein the slit receives an upper portion of one of the two adjacent side panels so that the lower portion of the joint cap does not interfere with the two adjacent side panels, and
wherein the lower portion of the joint cap is exterior to the two adjacent side panels that interconnect to define the vertically extending joint.

2. The novelty pet bed of claim 1,
wherein the slit is a first slit that receives the upper portion of a first one of the two adjacent side panels,
wherein a second slit extends upwardly to at least the height the vertically extending joint, and
wherein the second slit that receives the upper portion of a second one of the two adjacent side panels.

3. The novelty pet bed of claim 3,
wherein the length of the first slit is the same as a length of the second slit.

4. The novelty pet bed of claim 1,
wherein each of the side panels side panels includes an exterior surface with ornamentation.

5. The novelty pet bed of claim 1, wherein the four side panels includes:
a first side panel defining a series of slots; and
a second side panel including a series of tabs configured to matingly engage the series of slots in the first side panel to interconnect the first side panel with the second side panel.

6. The novelty pet bed of claim 1, wherein the upper portion of the joint cap presses the two adjacent side panels together and more securely interconnects the two adjacent side panels when mounted to the vertically extending joint.

7. A novelty pet bed comprising:
four side panels interconnectable to define a pet bed frame,
wherein the four side panels of the pet bed frame define a void configured to receive a plush pet bed, and
wherein two adjacent side panels interconnect to each other using a first securing means,
wherein the two adjacent side panels define a vertically extending joint; and
a bottom panel interconnectable to a lower edge of each of the four side panels using a second securing means that is different from the first securing means,
wherein the bottom panel when connected to the four side panels defining the pet bed frame supports the plush pet bed and retains the plush pet bed within the void,
wherein the first securing means comprises a first one of the four side panels with a side edge defined by a series of outwardly protruding tabs, and
wherein the first securing means further comprises a second one of the four side panels with a side edge defined by a series of vertically oriented slots configured to matingly engage the outwardly protruding tabs of the first side panel to interconnect the first side panel with the second side panel to define the vertically extending joint.

8. The novelty pet bed of claim 7,
wherein each of the outwardly protruding tabs is a hook,
wherein the hook comprises:
an outwardly protruding member at a proximal end of the hook; and
a downwardly protruding member at a distal end of the hook,
wherein the outwardly protruding member and the downwardly protruding member cooperatively define an engaging interior area of the hook having a width, and
wherein the width of the engaging interior area corresponds to a thickness of the second one of the four side panels.

9. The novelty pet bed of claim 8, wherein at least one downwardly extending member includes a hole defined by a predefined diameter, the novelty pet bed further comprising:
a push pin defined by a diameter corresponding to the predefined diameter of the hole of the downwardly extending member,
wherein the push pin, when inserted through the hole of the downwardly extending member, prevents separation of the first side panel from the second side panel.

10. The novelty pet bed of claim 7, wherein each of the four side panels have a horizontally oriented lower slot proximate to the lower edge of the panel, wherein the bottom panel comprises:
at least one outwardly protruding tab located along each side of the bottom panel,
wherein a location of each outwardly protruding tab of the bottom panel corresponds to a location of the lower slot of the corresponding side panel, and
wherein each outwardly protruding tab of the bottom panel is received within the corresponding lower slot of the corresponding side panel after the novelty pet bed is assembled.

11. The novelty pet bed of claim 10, wherein a distal end of the outwardly protruding tab extends beyond an exterior surface of the corresponding side panel, and wherein the distal end of the outwardly protruding tab that extends beyond the exterior surface includes a hole, the novelty pet bed further comprising:
a push pin defined by a diameter corresponding to the predefined diameter of the hole of the outwardly protruding tab,
wherein the push pin, when inserted through the hole of the outwardly protruding tab, prevents separation of the first side panel from the second side panel.

12. The novelty pet bed of claim 7, further comprising:
a plurality of brackets,
wherein, for each one of the four side panels, at least one bracket is secured to a lower edge of the side panel and to an edge of the bottom panel to rigidly secure the assembled novelty pet bed.

13. The novelty pet bed of claim 12, further comprising:
a cover,
wherein, for each one of the four side panels, at least one bracket is secured to a lower edge of the side panel and to an edge of the cover to rigidly secure the assembled novelty pet bed.

14. The novelty pet bed of claim 7, further comprising:
a cover,
wherein an upper edge of each of the four side panels include at least one upwardly protruding tab,
wherein the cover includes a plurality of slots proximate to each edge of the cover, and
wherein each slot is configured to engage a corresponding upwardly protruding tab.

15. The novelty pet bed of claim 7, further comprising:
a cover,
wherein an upper edge of each of the four side panels include at least one upwardly protruding panel tabs,
wherein each edge of the cover includes an outwardly extending cover tab that extends beyond an outside surface of the corresponding side panel,
wherein each outwardly extending cover tab includes a slot, and
wherein each slot is configured to engage a corresponding upwardly protruding panel tab.

16. The novelty pet bed of claim 7, further comprising:
a cover,
wherein the upper edge of each of the four side panels includes a plurality of upwardly protruding panel tabs that define a plurality of notches,
wherein each edge of the cover includes an outwardly extending cover tab that extends beyond an outside surface of the corresponding side panel,
wherein each outwardly extending cover tab includes a slot, and
wherein each slot is configured to engage a corresponding upwardly protruding panel tab.

17. The novelty pet bed of claim 7,
wherein at least one of the four side panels define a window,
wherein a pet enters the novelty pet bed through the window, and
wherein the pet exits the novelty pet bed through the window.
